(19) United States
(12) Patent Application Publication
(10) Pub. No.: US 2016/0039306 A1
(43) Pub. Date: Feb. 11, 2016

(54) ELECTRICAL SOURCE CONTROL APPARATUS

(71) Applicant: TOYOTA JIDOSHA KABUSHIKI KAISHA, Toyota-shi, Aichi-ken (JP)

(72) Inventor: Masaki OKAMURA, Toyota-shi (JP)

(73) Assignee: TOYOTA JIDOSHA KABUSHIKI KAISHA, Toyota-shi (JP)

(21) Appl. No.: 14/778,757

(22) PCT Filed: Mar. 19, 2014
(86) PCT No.: PCT/JP2014/057565

§ 371 Date: Sep. 21, 2015

(30) Foreign Application Priority Data
Mar. 22, 2013 (JP) 2013-059657

(51) Int. Cl. B60L 11/18

(52) U.S. Cl. CPC B60L 11/1868; B60L 11/1859; B60L 11/1861; Y10S 903/907

(57) ABSTRACT

An electrical source control apparatus (40) controls a vehicle (1) which travels by using an electrical source system (30) including first electrical source (31) and a second electrical source (32), the electrical source control apparatus has: an adjusting device (40) configured to transmit an electrical power between the first and second electrical sources by a desired transmitting rate which represents an amount of the electrical power which should be transmitted for a unit time period and thus to adjust a residual power level of at least one of the first and second electrical sources; and a setting device (40) configured to set the transmitting rate such that the transmitting rate varies depending on a speed of the vehicle.

### TECHNICAL FIELD

The present invention relates to an electrical source control apparatus for controlling a vehicle which travels by using an electrical source system including two types of electrical sources, for example.

### BACKGROUND ART

A vehicle (for example, an Electrical Vehicle or a Hybrid Vehicle) which has an electrical source system including two types of electrical sources is proposed (see Patent Literatures 1 to 2). An electrical source which is capable of discharging (namely, outputting) a constant electrical power over a long time and an electrical source which is capable of performing a rapid discharge/charge (namely, output/input) are used as two types of electrical sources, for example.

Here, the Patent Literature 1 discloses a control method by which all of a required output for the discharge is satisfied by the output of a battery, if the required output for the discharge which is required for an electrical source apparatus is equal to or less than a maximum output of the battery in a power-running state. Moreover, the Patent Literature 1 discloses a control method by which the excess of the required output for the discharge which is more than the maximum output of the battery is satisfied by the output of a capacitor (alternatively, all of the required output for the discharge is satisfied by the output of the capacitor), if the required output for the discharge which is required for the electrical source apparatus is more than the maximum output of the battery. This control method prevents a rapid discharge from the battery and thus suppresses a deterioration of the battery.

Moreover, the Patent Literature 2 discloses a control method which increases a share (rate) of the charge to a large capacity type of condenser by restricting the charge to a battery, when a braking (a regeneration) is performed. This control method prevents a rapid charge to the battery and thus suppresses a deterioration of the battery.

### CITATION LIST

### Patent Literature

Patent Literature 1: Japanese Patent Application Laid Open No. Hei7-245808

Patent Literature 2: Japanese Patent Application Laid Open No. Hei5-30608

### SUMMARY OF INVENTION

### Technical Problem

By the way, the electrical source system including two types of electrical sources sometimes transmits (namely, transfers) the electrical power between two types of electrical sources in order to adjust a SOC of each electrical source (for example, to set it equal to a SOC center which is a target amount). However, the Patent Literature 1 does not disclose how the electrical power is transmitted between the battery and the capacitor at all. Similarly, the Patent Literature 2 does not disclose how the electrical power is transmitted between the battery and the condenser at all. Namely, the Patent Literatures 1 and 2 do not disclose how to effectively use the battery and the capacitor (condenser) whose characteristics are different from each other when the electrical power is transmitted between two types of electrical sources to adjust the SOC of each electrical source. Therefore, there is a possibility that the battery and the capacitor cannot be used effectively, which is a technical problem. As a result, there is a possibility that a driving performance of the vehicle, a fuel efficiency or the like deteriorates.

The subject to be solved by the present invention includes the above as one example. It is therefore an object of the present invention to provide an electrical source control apparatus which is capable of using two types of electrical sources more effectively in a vehicle having two types of electrical sources.

### Solution to Problem

<1>

In order to solve the above described problem, an electrical source control apparatus of the present invention is an electrical source control apparatus for controlling a vehicle which travels by using an electrical source system including both of a first electrical source and a second electrical source whose capacity is smaller than that of the first electrical source and whose output is larger than that of the first electrical source, the electrical source control apparatus is provided with: an adjusting device configured to transmit an electrical power between the first and second electrical sources by a desired transmitting rate which represents an amount of the electrical power which should be transmitted for a unit time period and thus to adjust a residual power level of at least one of the first and second electrical sources; and a setting device configured to set the transmitting rate such that the transmitting rate varies depending on a speed of the vehicle.

The electrical source control apparatus of the present invention is capable of controlling the vehicle which travels by using the electrical source system including both of the first and second electrical sources.

The vehicle which travels by using the above described electrical source system typically travels by using an electrical power outputted from the electrical source system, when the vehicle is in a power-running state. Specifically, for example, the vehicle travels by using a driving power of a rotating electrical machine which operates by using the electrical power outputted from the electrical source system. As a result, one or both of the first and second electrical sources often outputs the electrical power (namely, discharges) when the vehicle is in the power-running state. On the other hand, the vehicle travels while inputting the electrical power into the electrical source system, when the vehicle is in a regeneration state. Specifically, for example, the vehicle travels while inputting the electrical power, which is generated by the regeneration of the rotating electrical machine, into the electrical source system. As a result, the electrical power is often inputted to (namely, charges) one or both of the first and second electrical sources when the vehicle is in the regeneration state.

Here, the first electrical source is an electrical source (what we call a high capacity type electrical source) whose capacity is larger than the capacity of the second electrical source. Therefore, the first electrical source is capable of outputting the constant electrical power over a longer time than the second electrical source. On the other hand, the second electrical source is an electrical source (what we call a high output (high power) type electrical source) whose output is larger than the output of the first electrical source. Therefore, the second electrical source is capable of performing an input/output of the electrical power more rapidly than the first electrical source.

Incidentally, a battery may be used as the first electrical source and a capacitor (in other words, a condenser) may be used as the second electrical source, for example. Alternatively, a high capacity type battery (namely, a battery whose capacity is larger than that of a high output type battery) may be used as the first electrical source and the high output type battery (namely, a battery whose output is larger than that of the high capacity type battery) may be used as the second electrical source, for example. Alternatively, a high capacity type capacitor (namely, a capacitor whose capacity is larger than that of a high output type capacitor) may be used as the first electrical source and the high output type capacitor (namely, a capacitor whose output is larger than that of the high capacity type capacitor) may be used as the second electrical source, for example.

In order to control the above described vehicle (in other words, the electrical source system which the above described vehicle is provided with), the electrical source control apparatus of the present invention is provided with the adjusting device and the setting device.

The adjusting device adjusts at least one of the residual power level of the first electrical source (namely, a residual amount of the electrical power which is stored in the first electrical source, and a SOC (State Of Charge) for example) and the residual power level of the second electrical source (namely, a residual amount of the electrical power which is stored in the second electrical source, and a SOC (State Of Charge) for example). For example, the adjusting device may adjust the residual power level of the first electrical source to set the residual power level of the first electrical source equal to a target amount (in other words, to make the residual power level of the first electrical source follow up the target amount). Namely, the adjusting device may adjust the residual power level of the first electrical source such that a difference between the residual power level of the first electrical source and the target amount becomes smaller (preferably, becomes zero). The adjusting device may similarly adjust the residual power level of the second electrical source to set the residual power level of the second electrical source equal to a target amount (in other words, to make the residual power level of the second electrical source follow up the target amount). Namely, the adjusting device may adjust the residual power level of the second electrical source such that a difference between the residual power level of the second electrical source and the target amount becomes smaller (preferably, becomes zero).

In this case, the adjusting device may control the first and second electrical sources such that at least one of an input (namely, charge) of a predetermined amount of the electrical power into the first electrical source and an output (namely, discharge) of a predetermined amount of the electrical power from the first electrical source is performed, in order to adjust the residual power level of the first electrical source. The adjusting device may similarly control the first and second electrical sources such that at least one of an input (namely, charge) of a predetermined amount of the electrical power into the second electrical source and an output (namely, discharge) of a predetermined amount of the electrical power from the second electrical source is performed, in order to adjust the residual power level of the second electrical source.

Especially, the adjusting device adjusts the residual power level of at least one of the first and second electrical sources by transmitting, between the first and second electrical sources, the electrical power whose amount depends on the desired transmitting rate. Specifically, the adjusting device may adjust the residual power level of at least one of the first and second electrical sources by outputting the electrical power whose amount depends on the desired transmitting rate from the first electrical source to the second electrical source. In addition to or instead of this, the adjusting device may adjust the residual power level of at least one of the first and second electrical sources by outputting the electrical power whose amount depends on the desired transmitting rate from the second electrical source to the first electrical source. Incidentally, the “transmitting rate” is any parameter which directly or indirectly represents the amount of the electrical power which should be transmitted between the first and second electrical sources for the unit time period.

The setting device sets the “transmitting rate” which is used by the adjusting device on the basis of the speed of the vehicle. Specifically, the setting device sets the transmitting rate such that the transmitting rate varies depending on the speed of the vehicle (namely, the transmitting rate varies depending on the variation of the speed of the vehicle).

As described above, the electrical source control apparatus of the present invention is capable of changing the transmitting rate of the electrical power which is transmitted between the first and second electrical sources on the basis of the speed of the vehicle, when the electrical power is transmitted between the first and second electrical sources to adjust the residual power level of at least one of the first and second electrical sources. As a result, the electrical source control apparatus of the present invention is capable of effectively using the first and second electrical sources whose characteristics are different from each other, when the electrical power is transmitted between the first and second electrical sources to adjust the residual power level of at least one of the first and second electrical sources.

For example, a case where the transmitting rate becomes smaller as the speed of the vehicle becomes larger will be explained as one example.

Firstly, if the speed of the vehicle is relatively small, there is relatively low possibility that the relatively large amount of electrical power is generated by the regeneration. Thus, the electrical power which is transmitted between the first and second electrical sources is preferably used to adjust (for example, increase) the residual power level of at least one of the first and second electrical sources. Considering this situation, since the transmitting rate becomes relatively large when the speed of the vehicle is relatively small, the amount of the electrical power which is transmitted between the first and second electrical sources becomes relatively large. Thus, the residual power level of at least one of the first and second electrical sources is appropriately adjusted by the relatively large amount of electrical power which is transmitted between the first and second electrical sources.

Moreover, if the speed of the vehicle is relatively small, it is preferable that the residual power level of at least one of the first and second electrical sources become relatively large in preparation for the future acceleration or the like. Considering this situation, since the transmitting rate becomes relatively large when the speed of the vehicle is relatively small, the amount of the electrical power which is transmitted between the first and second electrical sources becomes relatively large. Thus, the relatively large amount of electrical power which is transmitted between the first and second electrical sources is capable of appropriately keeping the residual power level of at least one of the first and second electrical sources to be relatively large. As a result, even if the amount of the electrical power which should be outputted from the electrical source system becomes relatively large due to the acceleration or the like, at least one of the first and second electrical sources is capable of appropriately outputting the electrical power which is required for the acceleration or the like. Namely, the vehicle is capable of traveling to satisfy a driving performance such as an acceleration performance or the like.

Especially, the electrical power which the electrical source system should output is preferably satisfied by a temporal output of the electrical power from the second electrical source whose output is relatively large, when the electrical source system should temporarily output a large amount of electrical power in order to satisfy the driving performance (for example, to allow the vehicle to accelerate at a relatively large acceleration rate). Thus, it is preferable that the residual power level of the second electrical source is relatively large. Considering this situation, since the transmitting rate becomes relatively large when the speed of the vehicle is relatively small, the amount of the electrical power which is transmitted between the first and second electrical sources becomes relatively large. Thus, the relatively large amount of electrical power which is transmitted between the first and second electrical sources is capable of appropriately keeping the residual power level of the second electrical source to be relatively large. As a result, the second electrical source is capable of easily outputting the electrical power to satisfy the driving performance. In other words, such a situation does not occur easily that the second electrical source is not capable of outputting the electrical power at the timing when the second electrical source should temporarily output the electrical power in accordance with the variation of the electrical power which the electrical source system should output. Namely, the vehicle is capable of traveling to satisfy the driving performance such as the acceleration performance or the like.

On the other hand, if the speed of the vehicle is relatively large, there is relatively high possibility that the relatively large amount of electrical power is generated by the future regeneration. Thus, the electrical power which is transmitted between the first and second electrical sources is not necessarily used to adjust (for example, increase) the residual power level of at least one of the first and second electrical sources. Namely, the transmittance of the electrical power between the first and second electrical sources, which leads to a loss, is not necessarily used, because the residual power level of at least one of the first and second electrical sources can be adjusted (for example, increased) by using the electrical power which is generated by the regeneration. Considering this situation, since the transmitting rate becomes relatively small when the speed of the vehicle is relatively large, the amount of the electrical power which is transmitted between the first and second electrical sources becomes relatively small. Thus, the loss which is caused by the transmittance of the electrical power between the first and second electrical sources can be reduced, and thus a fuel efficiency of the vehicle is improved.

Moreover, if the speed of the vehicle is relatively large, the residual power level of at least one of the first and second electrical sources does not necessarily become relatively large, because there is relatively low possibility that the vehicle further accelerates. Thus, the electrical power which is transmitted between the first and second electrical sources is not necessarily used to adjust (for example, increase) the residual power level of at least one of the first and second electrical sources. Therefore, the transmittance of the electrical power between the first and second electrical sources, which leads to a loss, is not necessarily used. Considering this situation, since the transmitting rate becomes relatively small when the speed of the vehicle is relatively large, the amount of the electrical power which is transmitted between the first and second electrical sources becomes relatively small. Thus, the loss which is caused by the transmittance of the electrical power between the first and second electrical sources can be reduced, and thus a fuel efficiency of the vehicle is improved.

As described above, the electrical source control apparatus of the present invention is capable of effectively using the first and second electrical sources whose characteristics are different from each other, when the electrical power is transmitted between the first and second electrical sources to adjust the residual power level of at least one of the first and second electrical sources. As a result, the electrical source control apparatus of the present invention is capable of adjusting the residual power level of at least one of the first and second electrical sources while supporting different characteristics (for example, the characteristic which prioritizes the above described driving performance and the characteristic which prioritizes the fuel efficiency) which are required for the vehicle.

<2>

In another aspect of the electrical source control apparatus of the present invention, the setting device sets the transmitting rate such that the transmitting rate becomes smaller as the speed of the vehicle becomes larger.

According to this aspect, as described above, since the relatively large amount of electrical power is transmitted between the first and second electrical sources when the speed of the vehicle is relatively small, the residual power level of at least one of the first and second electrical sources can be adjusted appropriately and the vehicle is capable of traveling to satisfy the driving performance such as the acceleration performance or the like. On the other hand, since the relatively small amount of the electrical power is transmitted between the first and second electrical sources (namely, the loss which is caused by the transmittance of the electrical power between the first and second electrical sources can be reduced) when the speed of the vehicle is relatively large, the fuel efficiency of the vehicle is improved. Namely, the electrical source control apparatus is capable of adjusting the residual power level of at least one of the first and second electrical sources while supporting different characteristics (for example, the characteristic which prioritizes the above described driving performance and the characteristic which prioritizes the fuel efficiency) which are required for the vehicle.

<3>

In another aspect of the electrical source control apparatus of the present invention, the setting device sets the transmitting rate such that a first transmitting rate which represents an amount of the electrical power which should be outputted from the first electrical source to the second electrical source for the unit time period is different from a second transmitting rate which represents an amount of the electrical power which should be outputted from the second electrical source to the first electrical source for the unit time period.

According to this aspect, the setting device is capable of separately and independently setting the transmitting rate (the first transmitting rate) of the electrical power which is outputted from the first electrical source to the second electrical source and the transmitting rate (the second transmitting rate) of the electrical power which is outputted from the second electrical source to the first electrical source, by considering that the characteristic of the first electrical source is different from the characteristic of the second electrical source. As a result, the electrical source control apparatus is capable of adjusting the residual power level of at least one of the first and second electrical sources while using the first and second electrical sources whose characteristics are different from each other more effectively in accordance with the transmitting rates which vary depending on the speed of the vehicle. As a result, the electrical source control apparatus is capable of adjusting the residual power level of at least one of the first and second electrical sources while supporting different characteristics (for example, the characteristic which prioritizes the above described driving performance and the characteristic which prioritizes the fuel efficiency) which are required for the vehicle.

<4>

In another aspect of the above described electrical source control apparatus which sets the transmitting rate such that the first and second transmitting rates are different from each other, the setting device sets the transmitting rate such that the first transmitting rate becomes smaller as the speed of the vehicle becomes larger.

According to this aspect, the amount of the electrical power which is outputted from the first electrical source to the second electrical source becomes smaller as the speed of the vehicle becomes larger. Hereinafter, the technical effect of this aspect will be explained by using an example in which the residual power level of the second electrical source is adjusted (typically, increased) by using the electrical power which is outputted from the first electrical source to the second electrical source.

If the speed of the vehicle is relatively small, there is relatively low possibility that the relatively large amount of electrical power is generated by the regeneration. Thus, the electrical power which is outputted from the first electrical source to the second electrical source is preferably used to adjust (for example, increase) the residual power level of the second electrical source. Considering this situation, since the first transmitting rate becomes relatively large when the speed of the vehicle is relatively small, the amount of the electrical power which is outputted from the first electrical source to the second electrical source becomes relatively large. Thus, the residual power level of the second electrical source is appropriately adjusted by the relatively large amount of electrical power which is outputted from the first electrical source to the second electrical source.

Moreover, if the speed of the vehicle is relatively small, it is preferable that the residual power level of the second electrical source become relatively large in preparation for the future acceleration or the like. In other words, the electrical power which the electrical source system should output is preferably satisfied by a temporal output of the electrical power from the second electrical source whose output is relatively large, when the electrical source system should temporarily output a large amount of electrical power in order to satisfy the driving performance (for example, to allow the vehicle to accelerate at the relatively large acceleration rate) in the case where the speed of the vehicle is relatively small. Thus, it is preferable that the residual power level of the second electrical source is relatively large. Considering this situation, since the first transmitting rate becomes relatively large when the speed of the vehicle is relatively small, the amount of the electrical power which is outputted from the first electrical source to the second electrical source becomes relatively large. Thus, the relatively large amount of electrical power which is outputted from the first electrical source to the second electrical source is capable of appropriately keeping the residual power level of the second electrical source to be relatively large. As a result, even if the amount of the electrical power which should be outputted from the electrical source system becomes relatively large due to the acceleration or the like, the second electrical source is capable of appropriately outputting the electrical power which is required for the acceleration or the like. In other words, such a situation does not occur easily that the second electrical source is not capable of outputting the electrical power at the timing when the second electrical source should temporarily output the electrical power in accordance with the variation of the electrical power which the electrical source system should output. Namely, the vehicle is capable of traveling to satisfy the driving performance such as the acceleration performance or the like.

On the other hand, if the speed of the vehicle is relatively large, there is relatively high possibility that the relatively large amount of electrical power is generated by the future regeneration. Thus, the electrical power which is outputted from the first electrical source to the second electrical source is not necessarily used to adjust (for example, increase) the residual power level of the second electrical source. Namely, the electrical power is not necessarily outputted from the first electrical source to the second electrical source, which leads to the loss, because the residual power level of the second electrical source can be adjusted (for example, increased) by using the electrical power which is generated by the regeneration. Similarly, if the speed of the vehicle is relatively large, the residual power level of the second electrical source does not necessarily become relatively large, because there is relatively low possibility that the vehicle further accelerates. Therefore, the electrical power is not necessarily outputted from the first electrical source to the second electrical source, which leads to the loss. Considering this situation, since the first transmitting rate becomes relatively small when the speed of the vehicle is relatively large, the amount of the electrical power which is outputted from the first electrical source to the second electrical source becomes relatively small. Thus, the loss which is caused by the output of the electrical power from the first electrical source to the second electrical source can be reduced, and thus the fuel efficiency of the vehicle is improved.

As described above, in this aspect, the electrical source control apparatus is capable of adjusting the residual power level of at least one of the first and second electrical sources while supporting different characteristics (for example, the characteristic which prioritizes the above described driving performance and the characteristic which prioritizes the fuel efficiency) which are required for the vehicle.

<5>

In another aspect of the above described electrical source control apparatus which sets the transmitting rate such that the first and second transmitting rates are different from each other, the setting device sets the transmitting rate such that the second transmitting rate becomes larger as the speed of the vehicle becomes larger.

According to this aspect, the amount of the electrical power which is outputted from the second electrical source to the first electrical source becomes smaller as the speed of the vehicle becomes larger. Hereinafter, the technical effect of this aspect will be explained by using an example in which the residual power level of the second electrical source is adjusted (typically, decreased) by using the electrical power which is outputted from the second electrical source to the first electrical source.

If the speed of the vehicle is relatively small, it is preferable that the residual power level of the second electrical source become relatively large in preparation for the future acceleration or the like. Thus, the residual power level of the second electrical source is not necessarily adjusted (for example, decreased). Therefore, the electrical power is not necessarily outputted from the second electrical source to the first electrical source, which leads to the loss. Considering this situation, since the second transmitting rate becomes relatively small when the speed of the vehicle is relatively small, the amount of the electrical power which is outputted from the second electrical source to the first electrical source becomes relatively small. Thus, the loss which is caused by the output of the electrical power from the second electrical source to the first electrical source can be reduced, and thus the fuel efficiency of the vehicle is improved. Moreover, since the amount of the electrical power which is outputted from the second electrical source to the first electrical source becomes relatively small, the residual power level of the second electrical source keeps to be relatively large. Thus, even if the amount of the electrical power which should be outputted from the electrical source system becomes relatively large due to the acceleration or the like, the second electrical source is capable of appropriately outputting the electrical power which is required for the acceleration or the like. Namely, the vehicle is capable of traveling to satisfy the driving performance such as the acceleration performance or the like.

On the other hand, if the speed of the vehicle is relatively large, there is relatively high possibility that the relatively large amount of electrical power is generated by the future regeneration. Thus, the residual power level of the second electrical source is likely to need to be adjusted (for example, decreased) to maintain a space for additionally storing the electrical power which is generated by the regeneration, especially when the residual power level of the second electrical source is relatively large. Therefore, the electrical power is likely to need to be outputted from the second electrical source to the first electrical source to adjust (for example, decrease) the residual power level of the second electrical source. Considering this situation, since the second transmitting rate becomes relatively large when the speed of the vehicle is relatively large, the amount of the electrical power which is outputted from the second electrical source to the first electrical source becomes relatively large. Thus, the second electrical source is capable of maintaining the space for additionally store the electrical power which is generated by the regeneration, and thus the loss which is caused by a non-recovery of the electrical power which is generated by the regeneration becomes relatively small. As a result, the fuel efficiency of the vehicle is improved.

As described above, in this aspect, the electrical source control apparatus is capable of adjusting the residual power level of at least one of the first and second electrical sources while supporting different characteristics (for example, the characteristic which prioritizes the above described driving performance and the characteristic which prioritizes the fuel efficiency) which are required for the vehicle.

An operation and another advantage of the present invention will become more apparent from the embodiments explained below.

### BRIEF DESCRIPTION OF DRAWINGS

FIG. 1 is a block diagram illustrating one example of a structure of a vehicle of a present embodiment.

FIG. 2 is a flowchart illustrating an entire flow of the control operation of the vehicle in the present embodiment (substantially, the control operation of the electrical source system, and the SOC center control operation for the battery and the capacitor).

FIG. 3 is a graph illustrating a relationship between the speed of the vehicle and the power transmission rate.

FIG. 4 are graphs illustrating temperature characteristics of the battery and the capacitor.

FIG. 5 are graphs illustrating the relationship between the speed of the vehicle and the power transmission rate in the modified example.

### DESCRIPTION OF EMBODIMENTS

Hereinafter, with reference to drawings, an embodiment in which the present invention is applied to a vehicle 1 which has a motor generator 10 will be explained as one example of the embodiment of the present invention.

### (1) Structure of Vehicle

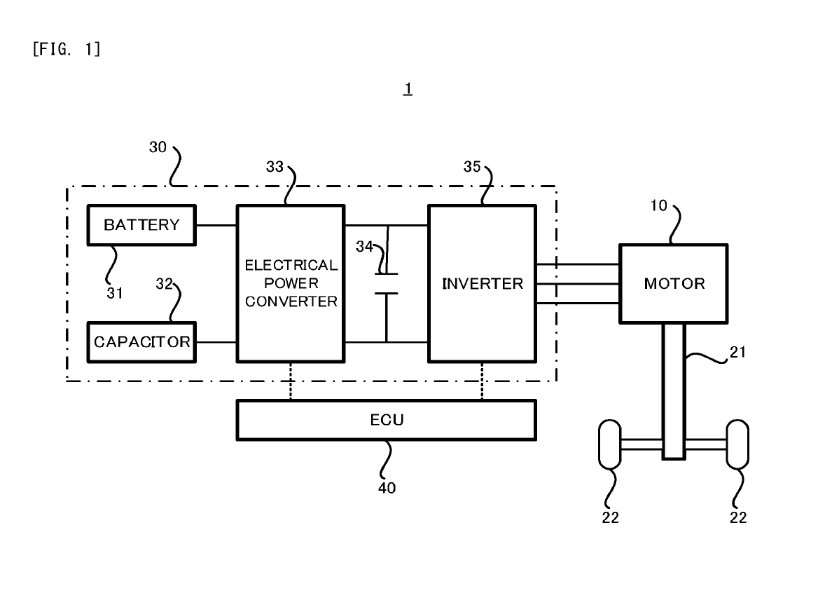

Firstly, with reference to FIG. 1, the structure of the vehicle 1 of the present embodiment will be explained. FIG. 1 is a block diagram illustrating one example of the structure of the vehicle 1 of the present embodiment.

As illustrated in FIG. 1, the vehicle 1 has a motor generator 10, an axle shaft 21, wheels 22, an electrical source system 30 and an ECU 40 which is one example of the “electrical source control apparatus (namely, the controlling device and the adjusting device)”.

The motor generator 10 operates by using an electrical power outputted from the electrical source system 30 to function as a motor for supplying a driving power (namely, a driving power which is required for the vehicle 1 to travel) to the axle shaft 21, when the vehicle 1 is in a power running state. Furthermore, the motor generator 10 functions as a generator for charging a battery 31 and a capacitor 32 in the electrical source system 30, when the vehicle 1 is in a regeneration state.

The axle shaft 21 is a transmission shaft for transmitting the driving power outputted from the motor generator 10 to the wheels 22.

The wheels 22 transmits the driving power transmitted via the axle shaft 21 to a road. FIG. 1 illustrates an example in which the vehicle 1 has one wheel 22 at each of right and left sides. However, it is actually preferable that the vehicle 1 have one wheel 22 at each of a front-right side, a front-left side, a rear-right side and a rear-left side (namely, have four wheels 22 in total).

Incidentally, FIG. 1 illustrates, as an example, the vehicle 1 which is provided with one motor generator 10. However, the vehicle 1 may be provided with two or more motor generators 10. Furthermore, the vehicle 1 may be provided with an engine in addition to the motor generator 10. Namely, the vehicle 1 in the present embodiment may be an EV (Electrical Vehicle) or a HV (Hybrid Vehicle).

The electrical source system 30 outputs the electrical power, which is required for the motor generator 10 to function as the motor, to the motor generator 10, when the vehicle 1 is in the power running state. Furthermore, the electrical power which is generated by the motor generator 10 functioning as the generator is inputted from the motor generator 10 to the electrical source system 30, when the vehicle 1 is in the regeneration state.

This electrical source system 30 is provided with the battery 31 which is one example of the “first electrical source”, the capacitor 32 which is one example of the “second electrical source”, an electrical power converter 33, a smoothing condenser 34 and an inverter 35.

The battery 31 is a secondary battery which is capable of performing an input/output (namely, charge/discharge) of the electrical power by using an electrochemical reaction (namely, a reaction for converting a chemical energy to an electrical energy) and the like. A lead battery, a lithium-ion battery, a nickel-hydrogen battery, a fuel battery or the like is one example of the battery 31, for example.

The capacitor 32 is capable of performing an input/output of the electrical power by using a physical effect or a chemical effect for storing electrical charge (namely, an electrical energy). An electrical double layer capacitor or the like is one example of the capacitor 32, for example.

Incidentally, two types of any electrical sources which is capable of performing the input/output of the electrical power may be used, instead of the battery 31 and the capacitor 32. In this case, the electrical source which is used instead of the battery 31 may be an electrical source whose capacity is larger (alternatively, whose energy density is larger) than that of the electrical source which is used instead of the capacitor 32. Alternatively, the electrical source which is used instead of the battery 31 may be an electrical source which is capable of outputting a constant electrical power over a longer time than the electrical source which is used instead of the capacitor 32. Moreover, the electrical source which is used instead of the capacitor 32 may be an electrical source whose output is larger than that of the electrical source which is used instead of the battery 31. Alternatively, the electrical source which is used instead of the capacitor 32 may be an electrical source which is capable of performing the input/output of the electrical power more rapidly (drastically) than the electrical source which is used instead of the battery 31. A high capacity type battery (namely, the electrical source which is used instead of the battery 31) and a high output type battery (namely, the electrical source which is used instead of the capacitor 32) or a high capacity type capacitor (namely, the electrical source which is used instead of the battery 31) and a high output type capacitor (namely, the electrical source which is used instead of the capacitor 32) are one example of two types of the electrical sources, for example.

The electrical power converter 33 converts the electrical power which is outputted from the battery 31 and the electrical power which is outputted from the capacitor 32 depending on a required electrical power which is required for the electrical source system 30 (typically, the required electrical power is an electrical power which the electrical source system 30 should output to the motor generator 10, for example), under the control of the ECU 40. The electrical power converter 33 outputs the converted electrical power to the inverter 35. Furthermore, the electrical power converter 33 converts the electrical power which is inputted from the inverter 35 (namely, the electrical power which is generated by the regeneration of the motor generator 10) depending on the required electrical power which is required for the electrical source system 30 (typically, the required electrical power is an electrical power which should be inputted to the electrical source system 30, and the required electrical power is substantially an electrical power which should be inputted to the battery 31 and the capacitor 32, for example), under the control of the ECU 40. The electrical power converter 33 outputs the converted electrical power to at least one of the battery 31 and the capacitor 32. The above described electrical power conversion allows the electrical power converter 33 to distribute the electrical power among the battery 31, the capacitor 32 and the inverter 35.

Incidentally, FIG. 1 illustrate, as an example, the electrical source system 30 having single electrical power converter 33 which is shared by the battery 31 and the capacitor 32. However, the electrical source system 30 may be provided with two or more electrical power converters 33 (for example, the electrical power converter 33 for the battery 31 and the electrical power converter 33 for the capacitor 32).

The smoothing condenser 34 smooths the variation of the electrical power which is supplied from the electrical power converter 33 to the inverter 35 (substantially, the variation of the electrical voltage at a source line between the electrical power converter 33 and the inverter 35), when the vehicle 1 is in the power running state. The smoothing condenser 34 similarly smooths the variation of the electrical power which is supplied to the electrical power converter 33 from the inverter 35 (substantially, the variation of the electrical voltage at the source line between the electrical power converter 33 and the inverter 35), when the vehicle 1 is in the regeneration state.

The inverter 35 converts the electrical power (DC (direct current) electrical power), which is outputted from the electrical power converter 33, to an AC (alternating current) electrical power, when the vehicle 1 is in the power running state. Then, the inverter 35 supplies the electrical power, which is converted to the AC electrical power, to the motor generator 10. Furthermore, the inverter 35 converts the electrical power (AC electrical power), which is generated by the motor generator 10, to the DC electrical power. Then, the inverter 35 supplies the electrical power, which is converted to the DC electrical power, to the electrical power converter 33.

The ECU 40 is an electrical controlling unit which is configured to control the whole of the operation of the vehicle 1. The ECU 40 is provided with a CPU (Central Processing Unit), a ROM (Read Only Memory), a RAM (Random Access Memory) and so on.

Especially, the ECU 40 controls the distribution of the electrical power which is performed by the above described electrical power converter 33. More specifically, the ECU 40 controls the distribution of the electrical power to set a SOC (State Of Charge) of the battery 31 equal to a battery SOC center which is a target amount of the SOC of the battery 31 and to set a SOC of the capacitor 32 equal to a capacitor SOC center which is a target amount of the SOC of the capacitor 32. In this case, the ECU 40 may set the SOC of the battery 31 equal to the battery SOC center by controlling the electrical power converter 33 such that the electrical power is outputted from the battery 31 to the capacitor 32 or the motor generator 10 or the electrical power is inputted from the capacitor 32 or the motor generator 10 to the battery 31. The ECU 40 may similarly set the SOC of the capacitor 32 equal to the capacitor SOC center by controlling the electrical power converter 33 such that the electrical power is outputted from the capacitor 32 to the battery 31 or the motor generator 10 or the electrical power is inputted from the battery 31 or the motor generator 10 to the capacitor 32.

Hereinafter, a control operation (hereinafter, it is referred to as a “SOC center control operation”) which is performed under the control of the ECU 40 and which is for setting the SOC of the battery 31 equal to the battery SOC center and for setting the SOC of the capacitor 32 equal to the capacitor SOC center will be explained in detail.

### (2) SOC Center Control Operation for Battery and Capacitor

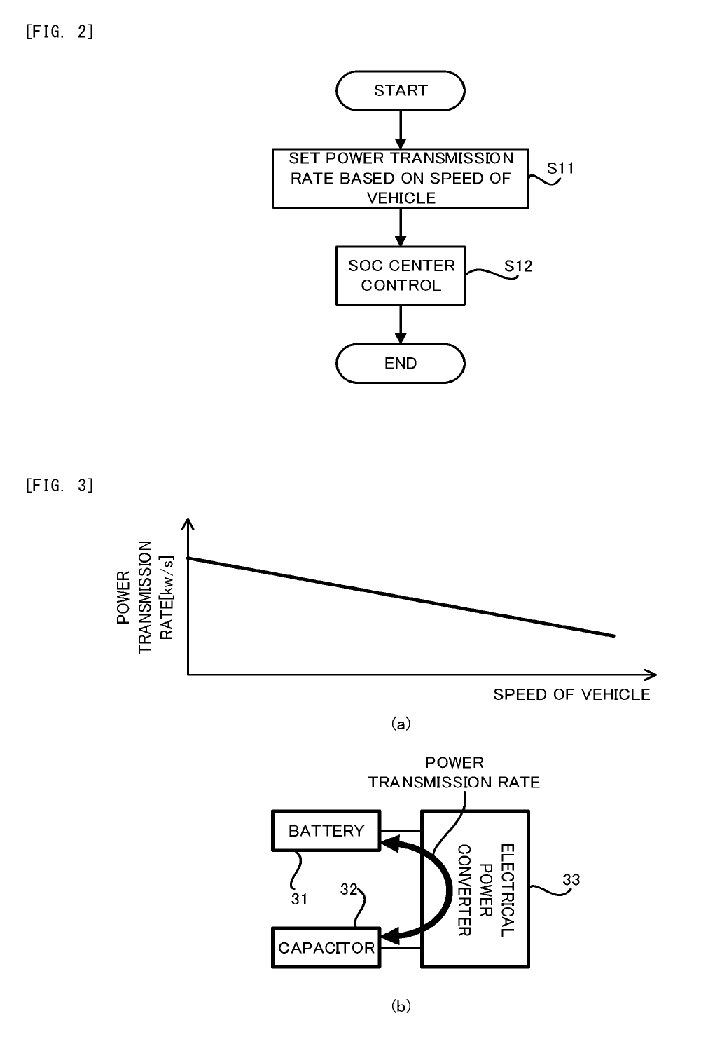

Next, with reference to FIG. 2, the control operation of the vehicle 1 in the present embodiment (substantially, the control operation of the electrical source system 30, and the SOC center control operation for the battery 31 and the capacitor 32) will be explained. FIG. 2 is a flowchart illustrating an entire flow of the control operation of the vehicle 1 in the present embodiment (substantially, the control operation of the electrical source system 30, and the SOC center control operation for the battery 31 and the capacitor 32).

As illustrated in FIG. 2, the ECU 40 sets a power transmission rate which represents (indicates) an amount of the electrical power which should be transmitted between the battery 31 and the capacitor 32 for a unit time period when the SOC center control operation for the battery 31 and the capacitor 32 is performed (step S11). Specifically, the ECU 40 sets the power transmission rate on the basis of a speed of the vehicle 1. Therefore, it is preferable that the ECU 40 obtain the speed of the vehicle 1 which is detected by a non-illustrated speed sensor or the like.

Here, with reference to FIG. 3, an operation of setting the power transmission rate on the basis of the speed of the vehicle 1 will be explained. FIG. 3 is a graph illustrating a relationship between the speed of the vehicle 1 and the power transmission rate.

As illustrated in FIG. 3(a), it is preferable that the ECU 40 set (in other words, adjust) the power transmission rate such that the power transmission rate becomes smaller as the speed of the vehicle 1 becomes larger. In this case, the ECU 40 may set the power transmission rate by referring to a graph (alternatively, a map, a table or the like) illustrated in FIG. 3(a).

Incidentally, as illustrated in FIG. 3(b), this “power transmission rate” represents both of the amount of the electrical power which is outputted from the battery 31 to the capacitor 32 for the unit time period and the amount of the electrical power which is outputted from the capacitor 32 to the battery 31 for the unit time period. Therefore, in the present embodiment, the amount of the electrical power which is outputted from the battery 31 to the capacitor 32 for the unit time period is equal to the amount of the electrical power which is outputted from the capacitor 32 to the battery 31 for the unit time period.

Again in FIG. 2, then, the ECU 40 performs the SOC center control operation for the battery 31 and the capacitor 32 (step S12). Specifically, the ECU 40 controls an input/output of the electrical power to/from the battery 31 and the capacitor 32 (substantially, controls the distribution of the electrical power performed by the electrical power converter 33) to set the SOC of the battery 31 equal to the battery SOC center. The ECU 40 similarly controls the input/output of the electrical power to/from the battery 31 and the capacitor 32 (substantially, controls the distribution of the electrical power performed by the electrical power converter 33) to set the SOC of the capacitor 32 equal to the capacitor SOC center.

More specifically, if the SOC of the battery 31 is smaller than the battery SOC center, the ECU 40 controls the distribution of the electrical power performed by the electrical power converter 33 such that the electrical power is outputted from any electrical power source to the battery 31 (namely, the battery 31 is charged). For example, the ECU 40 may control the distribution of the electrical power performed by the electrical power converter 33 such that the electrical power is outputted from the capacitor 32 or the motor generator 10 to the battery 31. As a result, the SOC of the battery 31 increases, and thus the ECU 40 is capable of setting the SOC of the battery 31 equal to the battery SOC center.

Similarly, if the SOC of the battery 31 is larger than the battery SOC center, the ECU 40 controls the distribution of the electrical power performed by the electrical power converter 33 such that the electrical power is outputted from the battery 31 to any load (namely, the battery 31 discharges). For example, the ECU 40 may control the distribution of the electrical power performed by the electrical power converter 33 such that the electrical power is outputted from the battery 31 to the capacitor 32 or the motor generator 10. As a result, the SOC of the battery 31 decreases, and thus the ECU 40 is capable of setting the SOC of the battery 31 equal to the battery SOC center.

Similarly, if the SOC of the capacitor 32 is smaller than the capacitor SOC center, the ECU 40 controls the distribution of the electrical power performed by the electrical power converter 33 such that the electrical power is outputted from any electrical power source to the capacitor 32 (namely, the capacitor 32 is charged). For example, the ECU 40 may control the distribution of the electrical power performed by the electrical power converter 33 such that the electrical power is outputted from the battery 31 or the motor generator 10 to the capacitor 32. As a result, the SOC of the capacitor 32 increases, and thus the ECU 40 is capable of setting the SOC of the capacitor 32 equal to the capacitor SOC center.

Similarly, if the SOC of the capacitor 32 is larger than the capacitor SOC center, the ECU 40 controls the distribution of the electrical power performed by the electrical power converter 33 such that the electrical power is outputted from the capacitor 32 to any load (namely, the capacitor 32 discharges). For example, the ECU 40 may control the distribution of the electrical power performed by the electrical power converter 33 such that the electrical power is outputted from the capacitor 32 to the battery 31 or the motor generator 10. As a result, the SOC of the capacitor 32 decreases, and thus the ECU 40 is capable of setting the SOC of the capacitor 32 equal to the capacitor SOC center.

As described above, the SOC of the battery 31 can be increased by the output of the electrical power from the capacitor 32 to the battery 31. However, the capacity of the capacitor 32 is smaller than the capacity of the battery 31 by bout single order of the magnitude. Therefore, there is high possibility that the electrical power which is outputted from the capacitor 32 to the battery 31 is too small to sufficiently increase the SOC of the battery 31. Namely, there is high possibility that the capacitor 32 is not capable of outputting, to the battery 31, the electrical power which is large to sufficiently increase the SOC of the battery 31. As a result, the electrical power which is outputted from the capacitor 32 to the battery 31 to perform the SOC center control for the battery 31 possibly becomes an unnecessary loss.

Similarly, as described above, the SOC of the battery 31 can be decreased by the output of the electrical power from the battery 31 to the capacitor 32. However, the capacity of the capacitor 32 is smaller than the capacity of the battery 31 by bout single order of the magnitude. Therefore, there is high possibility that the electrical power which is outputted from the battery 31 to the capacitor 32 is too small to sufficiently decrease the SOC of the battery 31. Namely, there is high possibility that the electrical power which is large to sufficiently decrease the SOC of the battery 31 cannot be outputted from the battery 31 to the capacitor 32. As a result, the electrical power which is outputted from the battery 31 to the capacitor 32 to perform the SOC center control for the battery 31 possibly becomes an unnecessary loss.

Considering these situations, the ECU 40 may not use the electrical power which is transmitted between the battery 31 and the capacitor 32, in order to perform the SOC center control for the battery 31. In other words, the electrical power which is transmitted between the battery 31 and the capacitor 32 is preferably and mainly used to perform the SOC center control for the capacitor 32. Hereinafter, for the purpose of clear explanation, an example in which the electrical power which is transmitted between the battery 31 and the capacitor 32 is mainly used to perform the SOC center control for the capacitor 32 will be explained.

Incidentally, if the electrical power which is transmitted between the battery 31 and the capacitor 32 is not used to perform the SOC center control for the battery 31, the above described power transmission rate substantially represents the amount of the electrical power which is transmitted between the battery 31 and the capacitor 32 for the unit time period to perform the SOC center control for the capacitor 32. In other words, the power transmission rate substantially represents the amount of the electrical power which is outputted from the battery 31 to the capacitor 32 to increase the SOC of the capacitor 32 and the amount of the electrical power which is outputted from the capacitor 32 to the battery 31 to decrease the SOC of the capacitor 32.

In the present embodiment, the ECU 40 performs the SOC center control operation such that the electrical power is transmitted in accordance with the power transmitting rate which is set at the step S11, when the electrical power is transmitted between the battery 31 and the capacitor 32. Specifically, for example, when the speed of the vehicle 1 is relatively small, the power transmitting rate which is larger than that used in the case where the speed of the vehicle 1 is relatively large is set. Therefore, when the ECU 40 performs the SOC center control operation under the situation that the speed of the vehicle 1 is relatively small, the ECU 40 controls the distribution of the electrical power which is performed by the electrical power converter 33 such that the amount of the electrical power which is transmitted between the battery 31 and the capacitor 32 is larger than that in the case where the SOC center control operation is performed under the situation that the speed of the vehicle 1 is relatively large. On the other hand, for example, when the speed of the vehicle 1 is relatively large, the power transmitting rate which is smaller than the rate used in the case where the speed of the vehicle 1 is relatively small is set. Therefore, when the ECU 40 performs the SOC center control operation under the situation that the speed of the vehicle 1 is relatively large, the ECU 40 controls the distribution of the electrical power which is performed by the electrical power converter 33 such that the amount of the electrical power which is transmitted between the battery 31 and the capacitor 32 is smaller than that in the case where the SOC center control operation is performed under the situation that the speed of the vehicle 1 is relatively small.

Here, if the speed of the vehicle 1 is relatively small, there is relatively low possibility that the relatively large amount of electrical power is generated by the regeneration. Thus, the electrical power which is transmitted between the battery 31 and the capacitor 32 is preferably used to perform the SOC center control operation for the capacitor 32 (for example, to increase the SOC of the capacitor 32). Considering this situation, since the power transmitting rate becomes relatively large when the speed of the vehicle 1 is relatively small, the amount of the electrical power which is transmitted between the battery 31 and the capacitor 32 becomes relatively large. Thus, the SOC center control operation for the capacitor 32 is appropriately performed by using the relatively large amount of electrical power which is transmitted between the battery 31 and the capacitor 32.

Moreover, if the speed of the vehicle 1 is relatively small, it is preferable that the SOC of the capacitor 32 become relatively large in preparation for the future acceleration or the like (namely, in preparation for the increase of the electrical power which is required for the electrical source system 10). Considering this situation, since the power transmitting rate becomes relatively large when the speed of the vehicle 1 is relatively small, the amount of the electrical power which is transmitted between the battery 31 and the capacitor 32 becomes relatively large. Thus, the SOC of the capacitor 32 keeps to be relatively large, because the capacitor 32 is charged by the relatively large amount of electrical power which is transmitted between the battery 31 and the capacitor 32. As a result, even if the amount of the electrical power which should be outputted from the electrical source system 30 becomes relatively large due to the acceleration or the like, the capacitor 32 is capable of appropriately outputting the electrical power which is required for the acceleration or the like. Namely, the vehicle 1 is capable of traveling to satisfy a driving performance such as an acceleration performance or the like.

Especially, the electrical power which the electrical source system 10 should output is preferably satisfied by a temporal output of the electrical power from the capacitor 32 whose output is relatively large, when the electrical source system 10 should temporarily output a large amount of electrical power in order to satisfy the driving performance (for example, to allow the vehicle 1 to accelerate at a relatively large acceleration rate) under the situation that the speed of the vehicle 1 is relatively small. Thus, it is preferable that the SOC of the capacitor 32 is relatively large. Considering this situation, since the power transmitting rate becomes relatively large when the speed of the vehicle 1 is relatively small, the amount of the electrical power which is transmitted between the battery 31 and the capacitor 32 becomes relatively large. Thus, the SOC of the capacitor 32 keeps to be relatively large, because the capacitor 32 is charged by the relatively large amount of electrical power which is transmitted between the battery 31 and the capacitor 32. As a result, the capacitor 32 is capable of easily outputting the electrical power to satisfy the driving performance. In other words, such a situation does not occur easily that the capacitor 32 is not capable of outputting the electrical power at the timing when the capacitor 32 should temporarily output the electrical power in accordance with the variation of the electrical power which the electrical source system 10 should output. Namely, the vehicle 1 is capable of traveling to satisfy the driving performance such as the acceleration performance or the like.

On the other hand, if the speed of the vehicle 1 is relatively large, there is relatively high possibility that the relatively large amount of electrical power is generated by the future regeneration. Thus, the electrical power which is transmitted between the battery 31 and the capacitor 32 is not necessarily used to perform the SOC center control operation for the capacitor 32 (for example, to increase). Namely, the transmittance of the electrical power between the battery 31 and the capacitor 32, which leads to a loss, is not necessarily used, because the SOC center control operation for the capacitor 32 can be performed (for example, increased) by using the electrical power which is generated by the regeneration. Considering this situation, since the power transmitting rate becomes relatively small when the speed of the vehicle 1 is relatively large, the amount of the electrical power which is transmitted between the battery 31 and the capacitor 32 becomes relatively small. Thus, the loss which is caused by the transmittance of the electrical power between the battery 31 and the capacitor 32 can be reduced, and thus a fuel efficiency of the vehicle 1 is improved.

Moreover, if the speed of the vehicle 1 is relatively large, the SOC of the capacitor 32 does not necessarily become relatively large, because there is relatively low possibility that the vehicle 1 further accelerates. Thus, the electrical power which is transmitted between the battery 31 and the capacitor 32 is not necessarily used to perform the SOC center control operation for the capacitor 32 (for example, to increase). Therefore, the transmittance of the electrical power between the battery 31 and the capacitor 32, which leads to a loss, is not necessarily used. Considering this situation, since the power transmitting rate becomes relatively small when the speed of the vehicle 1 is relatively large, the amount of the electrical power which is transmitted between the battery 31 and the capacitor 32 becomes relatively small. Thus, the loss which is caused by the transmittance of the electrical power between the battery 31 and the capacitor 32 can be reduced, and thus the fuel efficiency of the vehicle 1 is improved.

As described above, the ECU 40 is capable of effectively using the battery 31 and the capacitor 32, whose characteristics are different from each other, in accordance with the transmitting rate which varies depending on the speed of the vehicle 1, in performing the SOC center control operation for the battery 31 and the capacitor 32. As a result, the ECU 40 is capable of performing the SOC center control operation for the battery 31 and the capacitor 32 while supporting different characteristics (for example, the characteristic which prioritizes the above described driving performance and the characteristic which prioritizes the fuel efficiency) which are required for the vehicle.

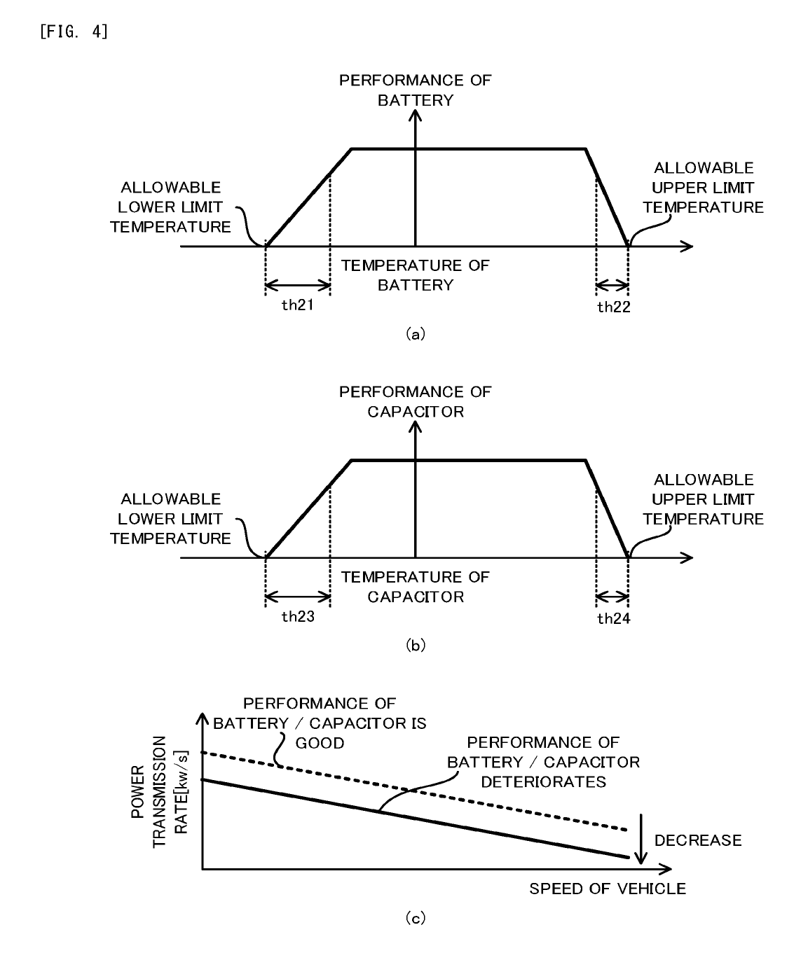

Incidentally, a performance (characteristic) of the battery 31 depends on a temperature (namely, a current temperature) of the battery 31. Specifically, as illustrated in FIG. 4(a), the performance of the battery 31 deteriorates more as a difference between the temperature of the battery 31 and a rated limit temperature becomes smaller, if the temperature of the battery 31 is close to the rated limit temperature (namely, an allowable lower limit temperature or an allowable upper limit temperature) which is determined from a specification of the battery 31. Namely, there is higher possibility that the battery 31 is not capable of performing a steady operation or a desired operation as the difference between the temperature of the battery 31 and the rated limit temperature becomes smaller, if the temperature of the battery 31 is close to the rated limit temperature.

A performance (characteristic) of the capacitor 32 similarly depends on a temperature (namely, a current temperature) of the capacitor 32. Specifically, as illustrated in FIG. 4(b), the performance of the capacitor 32 deteriorates more as a difference between the temperature of the capacitor 32 and a rated limit temperature becomes smaller, if the temperature of the capacitor 32 is close to the rated limit temperature (namely, an allowable lower limit temperature or an allowable upper limit temperature) which is determined from a specification of the capacitor 32. Namely, there is higher possibility that the capacitor 32 is not capable of performing a steady operation or a desired operation as the difference between the temperature of the capacitor 32 and the rated limit temperature becomes smaller, if the temperature of the capacitor 32 is close to the rated limit temperature.

Here, the ECU 40 may further adjust the power transmitting rate in order to prevent the deterioration of at least one of the battery 31 and the capacitor 32, when at least one of the battery 31 and the capacitor 32 is not capable of performing the steady operation or the desired operation. For example, as illustrated in FIG. 4(c), the ECU 40 may decrease the power transmission rate when at least one of the battery 31 and the capacitor 32 is not capable of performing the steady operation or the desired operation, compared to the rate used in the case where at least one of the battery 31 and the capacitor 32 is capable of performing the steady operation or the desired operation. In this case, the ECU 40 may set the power transmission rate such that the power transmission rate becomes smaller as the difference between the temperature of the battery 31 and the rated limit temperature becomes smaller or as the difference between the temperature of the capacitor 32 and the rated limit temperature becomes smaller.

In this case, for example, the ECU 40 may determine that the battery 31 is not capable of performing the steady operation or the desired operation, if the difference between the temperature of the battery 31 and the allowable lower limit temperature is smaller than a predetermined threshold value th21. Similarly, the ECU 40 may determine that the battery 31 is not capable of performing the steady operation or the desired operation, if the difference between the temperature of the battery 31 and the allowable upper limit temperature is smaller than a predetermined threshold value th22. Similarly, the ECU 40 may determine that the capacitor 32 is not capable of performing the steady operation or the desired operation, if the difference between the temperature of the capacitor 32 and the allowable lower limit temperature is smaller than a predetermined threshold value th23. Similarly, the ECU 40 may determine that the capacitor 32 is not capable of performing the steady operation or the desired operation, if the difference between the temperature of the capacitor 32 and the allowable upper limit temperature is smaller than a predetermined threshold value th24.

Incidentally, the predetermined threshold values th21 to th22 are preferably set, on the basis of the specification of the battery 31, to any values which can appropriately distinguish a condition that the battery 31 is capable of performing the steady operation or the desired operation from a condition that the battery 31 is not capable of performing the steady operation or the desired operation.

Similarly, the predetermined threshold values th23 to th24 are preferably set, on the basis of the specification of the capacitor 32, to any values which can appropriately distinguish a condition that the capacitor 32 is capable of performing the steady operation or the desired operation from a condition that the capacitor 32 is not capable of performing the steady operation or the desired operation.

### (3) Modified Example

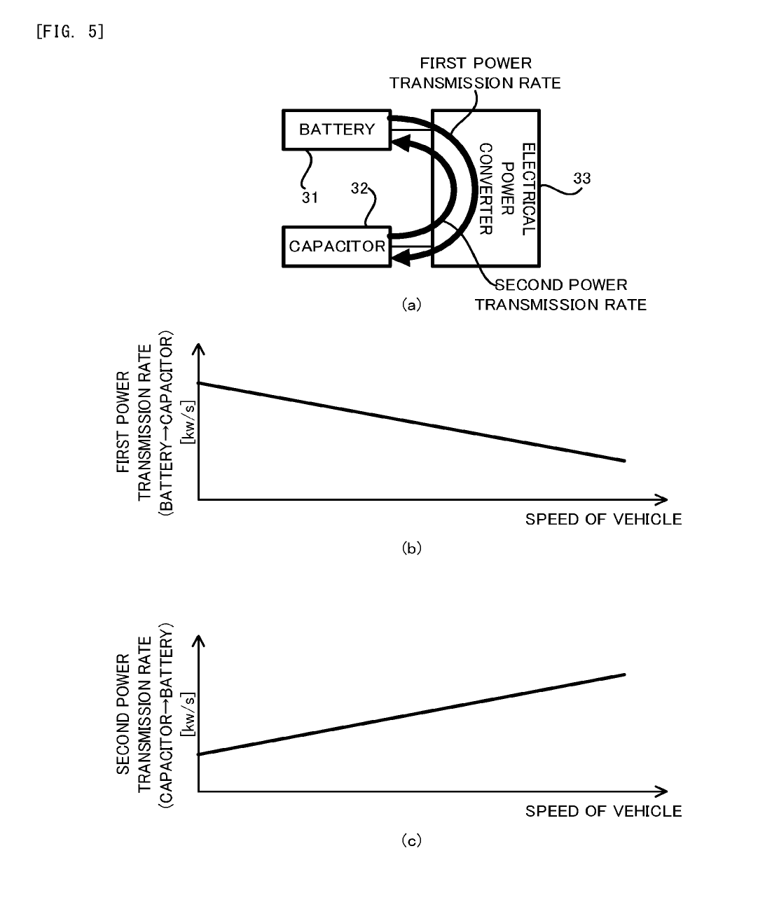

Next, with reference to FIG. 5, a modified example of the control operation of the vehicle 1 in the present embodiment (substantially, the control operation of the electrical source system 30, and the SOC center control operation for the battery 31 and the capacitor 32) will be explained. FIG. 5 are graphs illustrating the relationship between the speed of the vehicle 1 and the power transmission rate in the modified example.

In the above described embodiment, single power transmission rate which represents both of the amount of the electrical power which is outputted from the battery 31 to the capacitor 32 for the unit time period and the amount of the electrical power which is outputted from the capacitor 32 to the battery 31 for the unit time period is used. On the other hand, in the modified example, as illustrated in FIG. 5(a), a first power transmission rate which represents the amount of the electrical power which is outputted from the battery 31 to the capacitor 32 for the unit time period and a second power transmission rate which represents the amount of the electrical power which is outputted from the capacitor 32 to the battery 31 for the unit time period are used separately and independently.

Even in the modified example in which the first and second power transmission rates are used, the ECU 40 sets each of the first and second power transmission rates on the basis of the speed of the vehicle 1.

Specifically, as illustrated in FIG. 5(b), it is preferable that the ECU 40 set (in other words, adjust) the first power transmission rate such that the first power transmission rate becomes smaller as the speed of the vehicle 1 becomes larger. On the other hand, as illustrated in FIG. 5(c), it is preferable that the ECU 40 set (in other words, adjust) the second power transmission rate such that the second power transmission rate becomes larger as the speed of the vehicle 1 becomes larger.

As a result, for example, when the speed of the vehicle 1 is relatively small, the first power transmitting rate which is larger than that used in the case where the speed of the vehicle 1 is relatively large and the second power transmitting rate which is smaller than that used in the case where the speed of the vehicle 1 is relatively large are set. Therefore, when the ECU 40 performs the SOC center control operation under the situation that the speed of the vehicle 1 is relatively small, the ECU 40 controls the distribution of the electrical power which is performed by the electrical power converter 33 such that the amount of the electrical power which is outputted from the battery 31 to the capacitor 32 is larger than that in the case where the SOC center control operation is performed under the situation that the speed of the vehicle 1 is relatively large and the amount of the electrical power which is outputted from the capacitor 32 to the battery 31 is smaller than that in the case where the SOC center control operation is performed under the situation that the speed of the vehicle 1 is relatively large.

On the other hand, for example, when the speed of the vehicle 1 is relatively large, the first power transmitting rate which is smaller than that used in the case where the speed of the vehicle 1 is relatively small and the second power transmitting rate which is larger than that used in the case where the speed of the vehicle 1 is relatively small are set. Therefore, when the ECU 40 performs the SOC center control operation under the situation that the speed of the vehicle 1 is relatively large, the ECU 40 controls the distribution of the electrical power which is performed by the electrical power converter 33 such that the amount of the electrical power which is outputted from the battery 31 to the capacitor 32 is smaller than that in the case where the SOC center control operation is performed under the situation that the speed of the vehicle 1 is relatively small and the amount of the electrical power which is outputted from the capacitor 32 to the battery 31 is larger than that in the case where the SOC center control operation is performed under the situation that the speed of the vehicle 1 is relatively small.

Here, the first power transmission rate represents the amount of the electrical power which is outputted from the battery 31 to the capacitor 32 for the unit time period. Therefore, the first power transmission rate substantially defines an operation which is performed to increase the SOC of the capacitor 32 by using the electrical power which is outputted from the battery 31 to the capacitor 32. This first power transmission rate results in the following technical effect.

Firstly, if the speed of the vehicle 1 is relatively small, there is relatively low possibility that the relatively large amount of electrical power is generated by the regeneration. Thus, the electrical power which is outputted from the battery 31 to the capacitor 32 is preferably used to increase the SOC of the capacitor 32. Considering this situation, since the first power transmitting rate becomes relatively large when the speed of the vehicle 1 is relatively small, the amount of the electrical power which is outputted from the battery 31 to the capacitor 32 becomes relatively large. Thus, the ECU 40 is capable of increasing the SOC of the capacitor 32 by using the relatively large amount of electrical power which is outputted from the battery 31 to the capacitor 32.

Moreover, if the speed of the vehicle 1 is relatively small, it is preferable that the SOC of the capacitor 32 become relatively large in preparation for the future acceleration or the like. Considering this situation, since the first power transmitting rate becomes relatively large when the speed of the vehicle 1 is relatively small, the amount of the electrical power which is outputted from the battery 31 to the capacitor 32 becomes relatively large. Thus, the SOC of the capacitor 32 keeps to be relatively large, because the capacitor 32 is charged by the relatively large amount of electrical power which is outputted from the battery 31 to the capacitor 32. As a result, even if the amount of the electrical power which should be outputted from the electrical source system 30 becomes relatively large due to the acceleration or the like, the capacitor 32 is capable of appropriately outputting the electrical power which is required for the acceleration or the like. Namely, the vehicle 1 is capable of traveling to satisfy the driving performance such as the acceleration performance or the like.

On the other hand, if the speed of the vehicle 1 is relatively large, there is relatively high possibility that the relatively large amount of electrical power is generated by the future regeneration. Thus, the electrical power which is outputted from the battery 31 to the capacitor 32 is not necessarily used to increase the SOC of the capacitor 32. Similarly, if the speed of the vehicle 1 is relatively large, the SOC of the capacitor 32 does not necessarily become relatively large, because there is relatively low possibility that the vehicle 1 further accelerates. Thus, the electrical power which is outputted from the battery 31 to the capacitor 32 is not necessarily used to increase the SOC of the capacitor 32. Therefore, the electrical power is not necessarily outputted from the battery 31 to the capacitor 32, which leads to the loss. Considering this situation, since the first power transmitting rate becomes relatively small when the speed of the vehicle 1 is relatively large, the amount of the electrical power which is outputted from the battery 31 to the capacitor 32 becomes relatively small. Thus, the loss which is caused by the output of the electrical power from the battery 31 to the capacitor 32 can be reduced, and thus the fuel efficiency of the vehicle 1 is improved.

On the other hand, the second power transmission rate represents the amount of the electrical power which is outputted from the capacitor 32 to the battery 31 for the unit time period. Therefore, the second power transmission rate substantially defines an operation which is performed to decrease the SOC of the capacitor 32 by using the electrical power which is outputted from the capacitor 32 to the battery 31. This second power transmission rate results in the following technical effect.

Firstly, if the speed of the vehicle 1 is relatively small, it is preferable that the SOC of the capacitor 32 become relatively large in preparation for the future acceleration or the like. Thus, the SOC of the capacitor 32 is not necessarily decreased. Therefore, the electrical power is not necessarily outputted from the capacitor 32 to the battery 31, which leads to the loss. Considering this situation, since the second power transmitting rate becomes relatively small when the speed of the vehicle 1 is relatively small, the amount of the electrical power which is outputted from the capacitor 32 to the battery 31 becomes relatively small. Thus, the loss which is caused by the output of the electrical power from the capacitor 32 to the battery 31 can be reduced, and thus the fuel efficiency of the vehicle 1 is improved. Moreover, since the amount of the electrical power which is outputted from the capacitor 32 to the battery 31 becomes relatively small, the SOC of the capacitor 32 keeps to be relatively large. Thus, even if the amount of the electrical power which should be outputted from the electrical source system 30 becomes relatively large due to the acceleration or the like, the capacitor 32 is capable of appropriately outputting the electrical power which is required for the acceleration or the like. Namely, the vehicle 1 is capable of traveling to satisfy the driving performance such as the acceleration performance or the like.

On the other hand, if the speed of the vehicle 1 is relatively large, there is relatively high possibility that the relatively large amount of electrical power is generated by the future regeneration. Thus, the SOC of the capacitor 32 is likely to need to be decreased to maintain a space for additionally storing the electrical power which is generated by the regeneration, especially when the SOC of the capacitor 32 is relatively large. Therefore, the electrical power is likely to need to be outputted from the capacitor 32 to the battery 31 to decrease the SOC of the capacitor 32. Considering this situation, since the second power transmitting rate becomes relatively large when the speed of the vehicle 1 is relatively large, the amount of the electrical power which is outputted from the capacitor 32 to the battery 31 becomes relatively large. Thus, the capacitor 32 is capable of maintaining the space for additionally store the electrical power which is generated by the regeneration, and thus the loss which is caused by a non-recovery of the electrical power which is generated by the regeneration becomes relatively small. As a result, the fuel efficiency of the vehicle 1 is improved.

As described above, in the modified example, the ECU 40 is capable of using the battery 31 and the capacitor 32 whose characteristics are different from each other more effectively in accordance with the transmitting rates which vary depending on the speed of the vehicle 1, when the ECU 40 performs the SOC center control operation for the battery 31 and the capacitor 32. As a result, the ECU 40 is capable of performing the SOC center control operation for the battery 31 and the capacitor 32 while supporting different characteristics (for example, the characteristic which prioritizes the above described driving performance and the characteristic which prioritizes the fuel efficiency) which are required for the vehicle.

The present invention can be changed, if desired, without departing from the essence or spirit of the invention which can be read from the claims and the entire specification. An electrical source control apparatus, which involves such changes, is also intended to be within the technical scope of the present invention.

### DESCRIPTION OF REFERENCE CODES

1 vehicle
10 motor generator
21 axle shaft
22 wheel
30 electrical source system
31 battery
32 capacitor
33 electrical power converter
34 smoothing condenser
35 inverter
40 ECU

1. An electrical source control apparatus for controlling a vehicle which travels by using an electrical source system including both of a first electrical source and a second electrical source whose capacity is smaller than that of the first electrical source and whose output is larger than that of the first electrical source,
the electrical source control apparatus comprising a controller,
the controller being programmed to:
transmit an electrical power between the first and second electrical sources by a desired transmitting rate which represents an amount of the electrical power which should be transmitted for a unit time period and thus to adjust a residual power level of at least one of the first and second electrical sources; and
set the transmitting rate such that the transmitting rate varies depending on a speed of the vehicle.

2. The electrical source control apparatus according to claim 1 wherein
the controller is programmed to set the transmitting rate such that the transmitting rate becomes smaller as the speed of the vehicle becomes larger.

3. The electrical source control apparatus according to claim 1, wherein
the controller is programmed to set the transmitting rate such that a first transmitting rate which represents an amount of the electrical power which should be outputted from the first electrical source to the second electrical source for the unit time period is different from a second transmitting rate which represents an amount of the electrical power which should be outputted from the second electrical source to the first electrical source for the unit time period.

4. The electrical source control apparatus according to claim 3, wherein
the controller is programmed to set the transmitting rate such that the first transmitting rate becomes smaller as the speed of the vehicle becomes larger.

5. The electrical source control apparatus according to claim 3, wherein
the controller is programmed to set the transmitting rate such that the second transmitting rate becomes larger as the speed of the vehicle becomes larger.
